(19) United States
(12) Patent Application Publication
(10) Pub. No.: US 2022/0308927 A1
(43) Pub. Date: Sep. 29, 2022

(54) COMPOSED COMPUTE SYSTEM WITH ENERGY AWARE ORCHESTRATION

(71) Applicant: LENOVO Enterprise Solutions (Singapore) PTE. LTD., New Tech Park (SG)

(72) Inventors: Jiang Chen, Shanghai (CN); Fred Bower, III, Durham, NC (US); Caihong Zhang, Shanghai (CN)

(21) Appl. No.: 17/214,648

(22) Filed: Mar. 26, 2021

(51) Int. Cl. G06F 9/50; G06F 1/329

(52) U.S. Cl. CPC G06F 9/5011; G06F 9/505; G06F 9/5038; G06F 1/329

(57) ABSTRACT

A method includes determining that a compute node is scheduled to execute a workload. The compute node includes a remote resource available for use in execution of the workload. The remote resource functions as being installed on the compute node and is remote to the compute node and two or more remote hardware resources are available for selection as the remote resource. The method includes calculating, for each of the remote hardware resources, projected power consumption data related to execution of the workload. The projected power consumption data includes power consumption data based on an environment where each of the remote hardware resources is located. The method includes selecting a remote hardware resource for use during execution of the workload based on the projected power consumption data of the remote hardware resources and submitting the workload to the compute node for execution while using the selected remote hardware resource.

### FIELD

The subject matter disclosed herein relates to composed compute systems and more particularly relates to determining energy usage for two or more remote hardware resources available to a compute node in a composed compute system for execution of a workload.

### BACKGROUND

Job scheduling systems rely upon estimated or measured power consumption data from a given workload as a unit to make placement decisions. These measurements do not consider the effects of a job that produces power consumption demand upon multiple independent components. With composed systems, a workload often places power demands upon multiple elements in a shared fabric. The power demands are flexible, based upon the definition of the composed system.

Typically a composed system includes a compute node and its remote attached shared non-volatile storage resource or accelerator resource like a graphics processing unit (“GPU”), a field-programmable gate array (“FPGA”) or other accelerator. Normally job scheduling systems estimate the possible power consumption data for a given workload on compute node, and place the workload on the compute node that can best optimize the power consumption, while not considering the possible power consumption data for the shared storage resource or accelerator resource. Given the nature that a composed system is composed for the purpose of utilizing of shared resources, the workload will use the shared resources intensively, which results in large power consumption on those shared resources located in disparate containers or locations. Existing methods to consider power and cooling budgets when placing workload do not comprehend the power demands placed on shared components, as shared components typically provide a negligible addition to the workload's footprint.

### BRIEF SUMMARY

A method for a composed compute system with energy aware orchestration is disclosed. An apparatus and computer program product also perform the functions of the method. The method includes determining that a compute node is scheduled to execute a workload. The compute node includes a remote resource available for use in execution of the workload where the remote resource functions as being installed on the compute node and is remote to the compute node and two or more remote hardware resources are available for selection as the remote resource. The method includes calculating, for each of the two or more remote hardware resources, projected power consumption data related to execution of the workload. The projected power consumption data for the two or more remote hardware resources includes power consumption data based on an environment where each of the two or more the remote hardware resources is located. The method includes selecting a remote hardware resource of the two or more remote hardware resources for use during execution of the workload based on the projected power consumption data of the two or more remote hardware resources and submitting the workload to the compute node for execution while using the selected remote hardware resource.

An apparatus for a composed compute system with energy aware orchestration includes a processor and a memory. The memory that stores program code executable by the processor to determine that a compute node is scheduled to execute a workload. The compute node includes a remote resource available for use in execution of the workload. The remote resource functions as being installed on the compute node and is remote to the compute node and two or more remote hardware resources are available for selection as the remote resource. The program code is executable by the processor to calculate, for each of the two or more remote hardware resources, projected power consumption data related to execution of the workload. The projected power consumption data for the two or more remote hardware resources includes power consumption data based on an environment where each of the two or more the remote hardware resources is located. The program code is executable by the processor to select a remote hardware resource of the two or more remote hardware resources for use during execution of the workload based on the projected power consumption data of the two or more remote hardware resources and to submit the workload to the compute node for execution while using the selected remote hardware resource.

A program product for a composed compute system with energy aware orchestration includes a computer readable storage medium with program code. The program code is configured to be executable by a processor to perform operations that include determining that a compute node is scheduled to execute a workload. The compute node includes a remote resource available for use in execution of the workload. The remote resource functions as being installed on the compute node and is remote to the compute node and two or more remote hardware resources are available for selection as the remote resource. The program code is configured to be executable by a processor to perform operations that include calculating, for each of the two or more remote hardware resources, projected power consumption data related to execution of the workload. The projected power consumption data for the two or more remote hardware resources includes power consumption data based on an environment where each of the two or more the remote hardware resources is located. The program code is configured to be executable by a processor to perform operations that include selecting a remote hardware resource of the two or more remote hardware resources for use during execution of the workload based on the projected power consumption data of the two or more remote hardware resources, and submitting the workload to the compute node for execution while using the selected remote hardware resource.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for a composed compute system with energy aware orchestration;

FIG. 2 is a schematic block diagram illustrating another embodiment of a system for a composed compute system with energy aware orchestration;

FIG. 3 is a schematic block diagram illustrating one embodiment of an apparatus for a composed compute system with energy aware orchestration;

FIG. 4 is a schematic block diagram illustrating another embodiment of an apparatus for a composed compute system with energy aware orchestration;

FIG. 5 is a schematic flow chart diagram illustrating one embodiment of a method for a composed compute system with energy aware orchestration; and

FIG. 6 is a schematic flow chart diagram illustrating another embodiment of a method for a composed compute system with energy aware orchestration.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for a composed compute system with energy aware orchestration is disclosed. An apparatus and computer program product also perform the functions of the method. The method includes determining that a compute node is scheduled to execute a workload. The compute node includes a remote resource available for use in execution of the workload where the remote resource functions as being installed on the compute node and is remote to the compute node and two or more remote hardware resources are available for selection as the remote resource. The method includes calculating, for each of the two or more remote hardware resources, projected power consumption data related to execution of the workload. The projected power consumption data for the two or more remote hardware resources includes power consumption data based on an environment where each of the two or more the remote hardware resources is located. The method includes selecting a remote hardware resource of the two or more remote hardware resources for use during execution of the workload based on the projected power consumption data of the two or more remote hardware resources and submitting the workload to the compute node for execution while using the selected remote hardware resource.

In some embodiments, calculating, for each of the two or more remote hardware resources, the projected power consumption data related to execution of the workload includes calculating, for a remote hardware resource of the two or more remote hardware resources, the projected power consumption data using a power consumption model applicable to the remote hardware resource. In further embodiments, the method includes deriving the power consumption model for the remote hardware resource using power consumption data of one or more remote hardware resources related to execution of one or more previously executed workloads. In other embodiments, the one or more previously executed workloads are the same or similar to the workload scheduled for execution and the one or more remote hardware resources related to execution of the one or more previously executed workloads are similar to a remote hardware resource for which the power consumption model is being derived.

In other embodiments, deriving the power consumption model includes using, for each remote hardware resource of the two or more remote hardware resources, a baseline power consumption while not executing a workload, measurement of power consumption of the remote hardware resource during execution of a workload, a workload type, a device type of the remote hardware resource, a model number of the remote hardware resource, a temperature of the remote hardware resource, a temperature of a computing device where the remote hardware resource resides, configuration information for the remote hardware resource and/or an ambient temperature of a space where the remote hardware resource is located. In other embodiments, deriving the power consumption model includes using machine learning to derive the power consumption model.

In some embodiments, each of the two or more remote hardware resources is a central processing units (“CPU”), a graphics processing unit (“GPU”), a field-programmable gate array (“FPGA”), an accelerator, or a non-volatile data storage device. In other embodiments, selecting a remote hardware resource of the two or more remote hardware resources includes selecting a remote hardware resource of the two or more remote hardware resources based at least a part on management of heat within a space and/or one or more computing devices comprising the two or more remote hardware resources. In other embodiments, selecting a remote hardware resource of the two or more remote hardware resources includes selecting a remote hardware resource of the two or more remote hardware resources based on management of heat and one or more other workload execution performance factors for execution of the workload.

An apparatus for a composed compute system with energy aware orchestration includes a processor and a memory. The memory that stores program code executable by the processor to determine that a compute node is scheduled to execute a workload. The compute node includes a remote resource available for use in execution of the workload. The remote resource functions as being installed on the compute node and is remote to the compute node and two or more remote hardware resources are available for selection as the remote resource. The program code is executable by the processor to calculate, for each of the two or more remote hardware resources, projected power consumption data related to execution of the workload. The projected power consumption data for the two or more remote hardware resources includes power consumption data based on an environment where each of the two or more the remote hardware resources is located. The program code is executable by the processor to select a remote hardware resource of the two or more remote hardware resources for use during execution of the workload based on the projected power consumption data of the two or more remote hardware resources and to submit the workload to the compute node for execution while using the selected remote hardware resource.

In some embodiments, calculating, for each of the two or more remote hardware resources, the projected power consumption data related to execution of the workload includes program code executable by the processor to calculate, for a remote hardware resource of the two or more remote hardware resources, the projected power consumption data using a power consumption model applicable to the remote hardware resource. In other embodiments, the program code executable by the processor includes program code to derive the power consumption model for the remote hardware resource using power consumption data of one or more remote hardware resources related to execution of one or more previously executed workloads. In other embodiments, the one or more previously executed workloads are the same or similar to the workload scheduled for execution and the one or more remote hardware resources related to execution of the one or more previously executed workloads are similar to the remote hardware resource for which the power consumption model is being derived. In other embodiments, the program code executable to derive the power consumption model includes program code executable to use machine learning to derive the power consumption model.

In some embodiments, selecting a remote hardware resource of the two or more remote hardware resources includes selecting a remote hardware resource of the two or more remote hardware resources based at least a part on management of heat within a space and/or one or more computing devices comprising the two or more remote hardware resources. In other embodiments, selecting a remote hardware resource of the two or more remote hardware resources includes selecting a remote hardware resource of the two or more remote hardware resources based on management of heat and one or more other workload execution performance factors for execution of the workload.

A program product for a composed compute system with energy aware orchestration includes a computer readable storage medium with program code. The program code is configured to be executable by a processor to perform operations that include determining that a compute node is scheduled to execute a workload. The compute node includes a remote resource available for use in execution of the workload. The remote resource functions as being installed on the compute node and is remote to the compute node and two or more remote hardware resources are available for selection as the remote resource. The program code is configured to be executable by a processor to perform operations that include calculating, for each of the two or more remote hardware resources, projected power consumption data related to execution of the workload. The projected power consumption data for the two or more remote hardware resources includes power consumption data based on an environment where each of the two or more the remote hardware resources is located. The program code is configured to be executable by a processor to perform operations that include selecting a remote hardware resource of the two or more remote hardware resources for use during execution of the workload based on the projected power consumption data of the two or more remote hardware resources, and submitting the workload to the compute node for execution while using the selected remote hardware resource.

In some embodiments calculating, for each of the two or more remote hardware resources, the projected power consumption data related to execution of the workload includes calculating, for a remote hardware resource of the two or more remote hardware resources, the projected power consumption data using a power consumption model applicable to the remote hardware resource. In other embodiments, the program code is configured to be executable by a processor to perform operations that include deriving the power consumption model for the remote hardware resource using power consumption data of one or more remote hardware resources related to execution of one or more previously executed workloads. In other embodiments, the one or more previously executed workloads are the same or similar to the workload scheduled for execution and the one or more remote hardware resources related to execution of the one or more previously executed workloads are similar to the remote hardware resource for which the power consumption model is being derived.

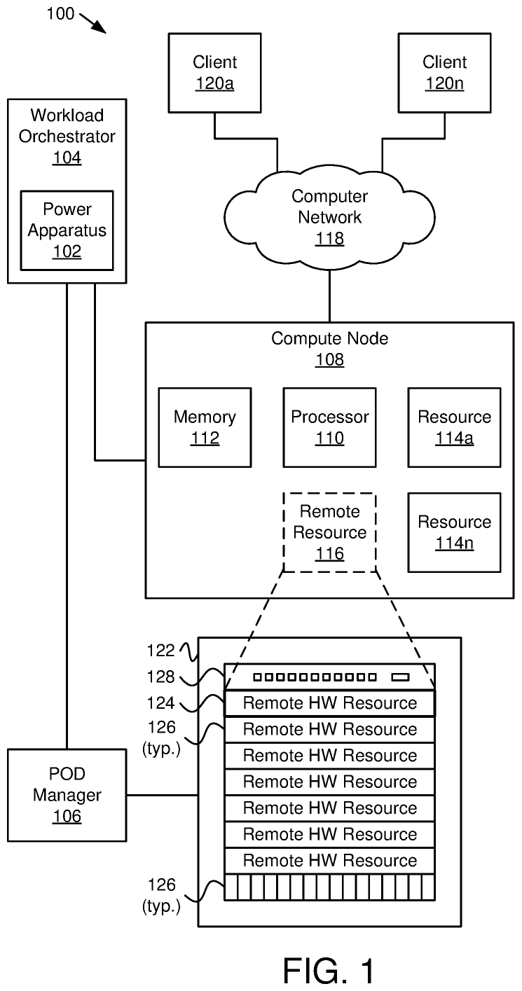

FIG. 1 is a schematic block diagram illustrating one embodiment of a system 100 for a composed compute system with energy aware orchestration. The system 100 includes a power apparatus 102 in a workload orchestrator 104, a POD manager 106, a compute node 108 with a processor 110, memory 112, resources 114a-114n and a remote resource 116, a rack 122 with a selected remote hardware resource 124, remote hardware resources 126, a switch 128, a computer network 118 and clients 120a-120n, which are described below.

The power apparatus 102 determines that the compute node 108 is scheduled to execute a workload where the compute node 108 includes a remote resource 116 that has access to other remote hardware resources 124, 126 that can be used in the execution of the workload. The remote resource 116, in some embodiments, is a software emulation of a hardware device so that the operating system of the compute node 108 treats the remote resource 116 the same as other resources 114a-114n (collectively or generically “114”) physically installed in the compute node 108. The resources 114 and remote hardware resources 124, 126 are devices such as a CPU, an accelerator, a graphics processing unit (“GPU”), a field-programmable gate array (“FPGA”), a CPU, a non-volatile data storage device or the like. For example, the compute node 108 may include a processor 110 with a CPU, non-volatile data storage, and a GPU but may have a remote resource 116 that is configured as a FPGA where the rack 122 includes multiple FPGAs.

While a single rack 122 is depicted, in other embodiments the remote hardware resources 124, 126 are located in multiple racks 122 or PODs. In some embodiments, a POD is a physical collection of multiple racks. In other embodiments, a POD is a pool of devices, which may or may not be in racks. Each remote hardware resource 124, 126 may be the same or may have different characteristics. The remote hardware resources 124, 126 typically also have different levels of current or scheduled utilization. In addition, the remote hardware resources 124, 126 have different energy usage where energy usage varies based on remote hardware resources 124, 126 version, current loading level, temperature, etc. For example, the remote hardware resources 124, 126 may include different GPUs, which may be installed in multiple racks 122. In some embodiments, a device, such as a rack 122, may include multiple GPUs. The GPUs may be a same version or different versions. In other embodiments, the GPUs available to the compute node 108 are in different PODs, which may be physically different devices.

The various remote hardware resources 124, 126 each have different power usage and heat load situations for a given workload and may also have different performances for the workload. The power apparatus 102 calculates projected power consumption data for each available remote hardware resources 124, 126 and compares the calculated projected workloads and then selects a remote hardware resource 124 for execution of the workload where the selection is based at least in part on the calculated projected power consumption data of the remote hardware resources 124, 126. The power apparatus 102 then submits the workload to the compute node 108 for execution while using the selected remote hardware resource 124. In one example, the power apparatus 102 submits the selected remote hardware resource 124 to the POD manager 106 and the POD manager 106 connects the selected remote hardware resource 124 to the remote resource 116 of the compute node 108 during execution of the workload.

The power apparatus 102 beneficially determines projected power consumption data for various remote hardware resources 124, 126 so that projected power consumption can be considered when selecting a remote hardware resource 124. Projected power consumption data for execution of the workload can be used with other power consumption data of a remote hardware device 124, 126 to evenly distribute heat loads, to avoid overwhelming cooling capabilities of a computing device housing the remote hardware resources 124, 126, etc. The power apparatus 102 allows projected power consumption data to be attributed to the actual computing device where the selected remote hardware device 124 that is used in conjunction with execution of the workload instead attributing the projected power consumption data of a compute node 108 with the associated remote resource 116. The power apparatus 102 is explained further below.

The system 100 includes a workload orchestrator 104. In some embodiments, the power apparatus 102 is part of or installed in the workload orchestrator 104. The workload orchestrator 104 controls where workloads are executed by selecting a compute node 108 for execution of the workload. Typically, the system 100 includes more than one compute node 108 and the workload orchestrator 104 balances usage of the compute nodes 108 based on current capacity and other factors. In some embodiments, the compute nodes 108 are different and the workload orchestrator 104 selects a compute node 108 for execution based on factors other than utilization of the various compute nodes 108. In some embodiments, the workload orchestrator 104 communicates with the POD manager 106 and directs the POD manager 106 to use one or more particular remote hardware resources 124, 126 for execution of a workload.

In some embodiments, the power apparatus 102 is separate from the workload orchestrator 104. For example, the power apparatus 102 may be in a server and may be separate from the workload orchestrator 104. The power apparatus 102 may communicate with the workload orchestrator 104 to determine that the compute node 108 is scheduled to execute workloads.

In some embodiments, the POD manager 106 monitors the remote hardware resources 124, 126 and provides information to the workload orchestrator 104. In the embodiment, the power apparatus 102 uses the information from the POD manager 106 to calculate projected power consumption of the remote hardware resources 124, 126, to select the remote hardware resource 124, etc. In some embodiments, the power apparatus 102 receives information directly from the remote hardware resources 124, 126. One of skill in the art will recognize other embodiments of the system 100 with a power apparatus 102 that may include a workload orchestrator 104 and/or a POD manager 106.

The compute node 108 is a computing device with a processor 110 and memory 112. In some embodiments, the processor 110 includes multiple cores. In some embodiments, applications are formatted as microservices that have associated workloads where each microservice performs one or more functions for an overall application. In some embodiments, the compute node 108 executes one or more virtual machines. Typically, each virtual machine executes a different instance of an operating system. A virtual machine, in some instances, services workloads for a client 120. In other embodiments, the compute node 108 executes one or more containers. Each container may be separated from other containers, virtual machines, etc. but may share an operating system kernel executing on the processor 110, may share libraries, etc. The clients 120 may use containers to execute workloads. The workload orchestrator 104, in some embodiments, schedules workloads to execute on particular virtual machines and/or containers where the virtual machines and containers are on various compute nodes 108.

The computer network 118 includes one or more network types, such as a wide area network (“WAN”), a fiber network, satellite network, a local area network (“LAN”), and the like. The computer network 118 may include two or more networks. The computer network 118 may include private networks or public networks, such as the Internet.

The wireless connection may be a mobile telephone network. The wireless connection may also employ a Wi-Fi network based on any one of the Institute of Electrical and Electronics Engineers (IEEE) 802.11 standards. Alternatively, the wireless connection may be a BLUETOOTH® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT-F® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application.

The system 100 includes one or more clients 120. Typically, a client 120 runs on a computing device and allows access to applications running on one or more compute nodes 108. In some embodiments, a client 120 has access to a virtual machine or container running on one or more compute nodes 108 where the client executes an application on a virtual machine or container to service workloads. Typically, virtual machines and containers provide a level of security where unauthorized clients (e.g. 120b-n), applications, etc. do not have access to a virtual machine or container of a client (e.g. 120a).

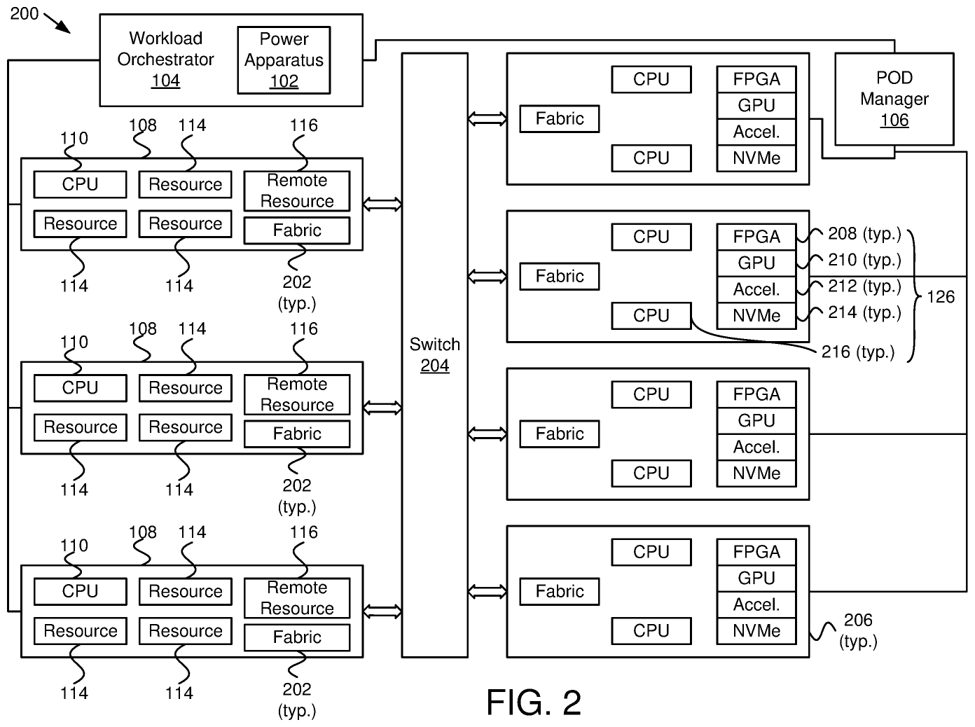

FIG. 2 is a schematic block diagram illustrating another embodiment of a system 200 for a composed compute system with energy aware orchestration. The system 200 includes a power apparatus 102 in a workload orchestrator 104, a POD manager 106, compute nodes 108 each with a CPU 110, resources 114, a remote resource 116 and a fabric adapter 202, a switch 204, a POD 206 with an FPGA, a GPU 210, an accelerator, an NVMe 214 and CPUs 216, which are described below.

The power apparatus 102, workload orchestrator 104, POD manager 106, compute nodes 108, CPU 110, resources 114 and remote resource 116 are substantially similar to those described above in relation to the system 100 of FIG. 1. The FPGA 208, GPU 210, Accelerator 212 and NVMe 214 are possible remote hardware resources and are substantially similar to the remote hardware resources 124. 126 described above in relation to the system 100 of FIG. 1. For simplicity of description below, the selected remote hardware resource 124 may also be referred to as a remote hardware resource 126. In the embodiment of the system 200 of FIG. 2, the remote hardware resources 126 are depicted in PODs 206. The PODs 206 are depicted separately and in some embodiments are separate computing devices. In some embodiments, each of the PODs 206 has a separate thermal environment. For example, each POD 206 may have separate cooling, one or more separate heat sinks, one or more separate fans, etc. so that thermal management is considered separately for each POD 206.

Each POD 206 is depicted with an FPGA 208, a GPU 210, an accelerator 212 and an NVMe 214 for convenience in illustrating that if the remote resource 116, for example, is an FPGA 208, different FPGAs 208 are available in different PODs 206 or at least may have different thermal environments. However, a POD 206 may be filled with remote hardware resources 126 of a same type. For example, a POD 206 may be filled with FPGAs 208 and there may be two or more PODs 206 with FPGAs 208. Other PODs 206 may be filled with GPUs 210, with accelerators 212, with non-volatile storage devices, etc. and the system 200 may include multiple PODs 206 with remote hardware resources 126 all of the same type. In other embodiments, a POD 206 may include different versions, different sizes, different current utilizations, etc. of a particular remote hardware resource 126 so that selection between a remote hardware resources 126 of a same category (e.g. FPGAs, GPUs 210, CPUs, etc.) within a same POD 206 would result in different projected power consumption data for each available remote hardware resource 126.

While NVMes 214 are depicted in the PODs 206, other non-volatile data storage devices may be included as remote hardware resources 126. In some examples, the non-volatile data storage devices may be a hard disk drive (“HDD”), a solid state storage drive (“SSD”), flash memory, an optical drive, or other type of non-volatile data storage device. For example, the non-volatile data storage device may be a serial attached SCSI (“SAS”) drive (“SCSI” is small computer system interface), a SATA drive (“SATA” is serial ATA or serial AT attachment), or the like. The non-volatile data storage devices may be electrically accessed or mechanically accessed. In some embodiments, the non-volatile data storage devices are connected to each other and to the compute node 108 through a storage area network (“SAN”).

In some embodiments, each POD 206 includes one or more CPUs 216, which may be used for access and control of the remote hardware resources 126. Each POD 206 and compute node 108 is depicted with a fabric adapter 202 and the compute nodes 208 are connected to the PODs 206 through a switch 204 over a network fabric. In some embodiments, the POD manager 106 controls connection between a particular compute node 108 and a particular POD 206. In some embodiments, the POD manager 106 controls connection between a remote resource 116 of a compute node 108 and a particular remote hardware resource 126 of a POD 206. In other embodiments, the POD manager 106 communicates with the workload orchestrator 104/power apparatus 102 and provides information to the power apparatus 102 useful in calculating projected power consumption data for available remote hardware resources 126.

Typically, the system 200, which may be called a composed compute system, requires a low latency, high speed connection between a remote resource 116 of a compute node 108 and a remote hardware resource 126 of a POD 206. Thus, the compute nodes 108 and PODs 206 are typically located relatively close. Typically, the compute nodes 108 and PODs 206 are at least in the same facility but may also be within a same space or adjacent spaces within the facility. Where a low latency, high speed connection suitable for using a remote hardware resource 126 for a compute node 108 is possible for greater distances between the remote hardware resources 126 and the compute nodes 108, the embodiments described herein may be used for such conditions. One of skill in the art will recognize other configurations of a composed systems 100, 200 where the embodiments described herein are applicable.

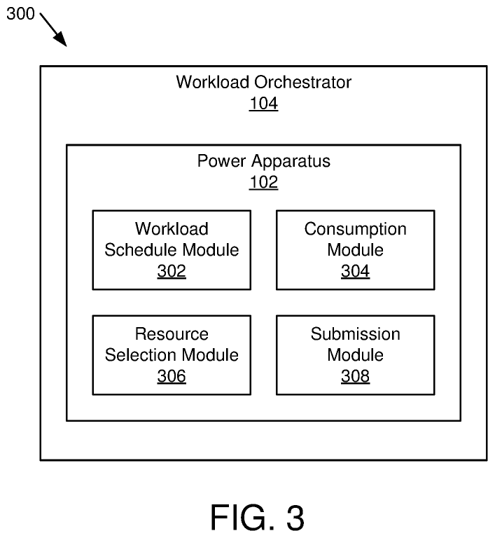

FIG. 3 is a schematic block diagram illustrating one embodiment of an apparatus 300 for a composed compute system with energy aware orchestration. The apparatus 300 includes an embodiment of the power apparatus 102 in an embodiment of the workload orchestrator 104 where the power apparatus 102 includes a workload schedule module 302, a consumption module 304, a resource selection module 306 and a submission module 308, which are described below.

The apparatus 300 includes a workload schedule module 302 configured to determine that a compute node 108 is scheduled to execute a workload. The compute node 108 includes a remote resource 116 available for use in execution of the workload. As discussed above, the remote resource 116 is not a physical device locate on the compute node 108 but instead is a software driver that accesses a remote hardware resource 126 located remote from the compute node 108 and that functions as being installed in the compute node 108. Two or more remote hardware resources 126 are available for selection as the remote resource 116.

The remote resource 116 is configured as a particular type of resource. For example, the remote resource 116 may be configured as an FPGA 208, may be configured as a GPU 210, etc. Typically, a remote resource 116 remains configured as a particular device type and does not change without reconfiguration of the compute node 108. However, the embodiments described herein may also be used for a remote resource 116 that is reconfigurable during operation. Typically, the operating system of the compute node 108 sends commands and communicates with the remote resource 116 as if the selected remote hardware resource 124 is installed in the compute node 108. If the remote resource 116 is installed as a GPU, the operating system of the compute node 108 treats the remote resource 116 as a GPU. However, any one of the multiple GPUs 210 in the various PODs 206 maybe connected to the compute node 108 to service the workload.

In some embodiments, the workload schedule module 302 works in conjunction with the workload orchestrator 104 to determine that the compute node 108 is scheduled to execute the workload. For example, the workload orchestrator 104 may receive a workload request from a client 120 and may assign the workload to a particular compute node 108 and the workload schedule module 302 determines that the workload orchestrator 104 has assigned the workload to the particular compute node 108.

The apparatus 300 includes a consumption module 304 configured to calculate, for each of the two or more remote hardware resources 126, projected power consumption data related to execution of the workload. The power consumption data for the two or more remote hardware resources 126 includes power consumption data based on an environment where each of the two or more the remote hardware resources 126 is located. For example, if a first remote hardware resource 126 is located in a first POD 206 and a second remote hardware resource 126 of the same type is located in a second POD 206, the consumption module 304 calculates the projected consumption data for the first remote hardware resource 126 based on thermal and loading conditions of the first POD 206 along with current conditions of the first remote hardware resource 126. Additionally, the consumption module 304 calculates the projected consumption data for the second remote hardware resource 126 based on thermal and loading conditions of the second POD 206 along with current conditions of the second remote hardware resource 126.

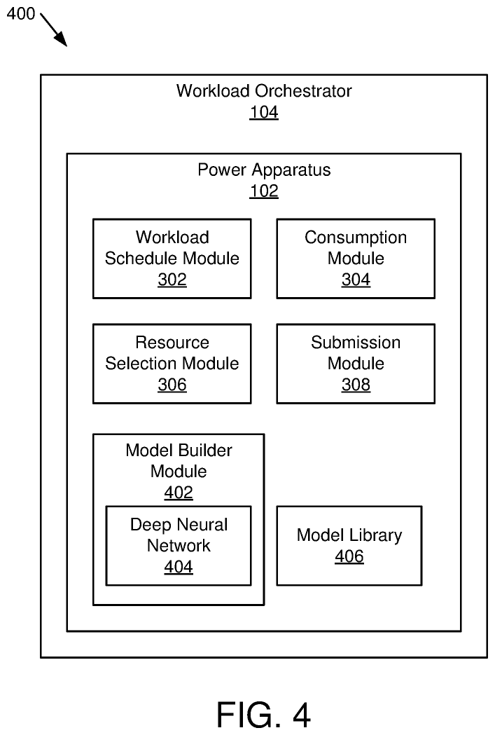

In some embodiments, the consumption module 304 is configured to calculate, for each of the two or more remote hardware resources 126, the projected power consumption data using a power consumption model applicable to the remote hardware resource 126. In some embodiments, the power consumption model includes equations to calculate projected power consumption data for a particular remote hardware resource 126. For example, the equations may include certain relationships, such as power consumption as a function of workload size, elements in the remote hardware resource 126 that are accessed by the workload, number of operations in the workload etc. Discussion of derivation of the power consumption model is below with respect to the apparatus 400 of FIG. 4.

In some embodiments, the apparatus 300 includes a resource selection module 306 configured to select a remote hardware resource 124 of the two or more remote hardware resources 124, 126 for use during execution of the workload based on the projected power consumption data of the two or more remote hardware resources 124, 126. In some embodiments, the resource selection module 306 selects a remote hardware resource 124 that has a lowest projected power consumption of the available remote hardware resources 124, 126. In other embodiments, the resource selection module 306 selects a remote hardware resource 124 based on other factors, such as heat management of the POD 206 and/or space of the POD 206 of the remote hardware resources 124, 126, performance of the remote hardware resources 124, 126, scheduled workloads for the remote hardware resources 124, 126, and the like. For example, the resource selection module 306 may use an algorithm with a scoring system that includes performance along with projected power consumption, power consumption budget limits for the POD 206 housing the remote hardware resource 126, and possibly other factors in selecting a remote hardware resource 124, 126 for use during execution of the workload.

As used herein using a remote hardware resource 124, 126 during execution of a workload includes using a remote hardware resource 124, 126 directly for execution of the workload or using a remote hardware resource 124, 126 indirectly while another resource 114, 126 executes the workload. For example, an FPGA 208, a GPU 210, an accelerator, a CPU, etc. may execute the workload directly while data from execution of a workload may be stored on or read from a non-volatile data storage device as a remote hardware resource 124, 126 while another device executes the workload. One of skill in the art will recognize other factors and algorithms for the resource selection module 306 to use during selection of a remote hardware resource 124.

The apparatus 300 includes a submission module 308 configured to submit the workload to the compute node 108 for execution while using the selected remote hardware resource 124. In some embodiments, the submission module 308 submits the workload directly to the compute node 108 with instructions to the POD manager 106 to use the selected remote hardware resource 124. In other embodiments, the submission module 308 works with the workload orchestrator 104 to submit the workload to the compute node 108 with direction to the POD manager 106 to use the selected remote hardware resource 124. In other embodiments, the submission module 308 convey a command to use the selected remote hardware resource 124 in another way. One of skill in the art will recognize other ways for the submission module 308 to submit the workload to the compute node 108 for execution while using the selected remote hardware resource 124.

FIG. 4 is a schematic block diagram illustrating another embodiment of an apparatus 400 for a composed compute system with energy aware orchestration. The apparatus 400 includes another embodiment of the power apparatus 102 in an embodiment of a workload orchestrator 104 where the power apparatus 102 includes a workload schedule module 302, a consumption module 304, a resource selection module 306 and a submission module 308, which are substantially similar to those described above in relation to the apparatus 300 of FIG. 3. The power apparatus 102 includes a model builder module 402 with a deep neural network 404 and/or includes a model library 406, which are described below.

The apparatus 400 includes a model builder module 402 configured to derive a power consumption model for a particular remote hardware resource 126 using power consumption data of one or more remote hardware resources 126 related to execution of one or more previously executed workloads. For example, where the model builder module 402 is deriving a power consumption model for a particular version of an FPGA 208, the model builder module 402 may use execution results from FPGAs 208 that are the same or similar version and may classify use execution results by workload type. The model builder module 402 may then use the execution results to identify trends or other characteristics to help with building a power consumption model for the particular version of FPGA 208. The model builder module 402 may use curve fitting, extrapolation or other techniques to build a power consumption model. The consumption module 304 then uses power consumption models for the particular remote hardware resources 126 being considered for use during execution of the workload to compute the projected power consumption data for the remote hardware resources 126.

In some embodiments, the model builder module 402 uses, for each remote hardware resource 126 of the two or more remote hardware resources 126, various parameters, which may be measured or are based on information about the remote hardware resources 126. The parameters may include a baseline power consumption while not executing a workload, measurement of power consumption of the remote hardware resource 126 during execution of a workload, a workload type, a device type of the remote hardware resource 126, a model number of the remote hardware resource 126, a temperature of the remote hardware resource 126, a temperature of a computing device (e.g. POD 206) where the remote hardware resource 126 resides, configuration information for the remote hardware resource 126 and/or an ambient temperature of a space where the remote hardware resource 126 is located. One of skill in the art will recognize other parameters useful in deriving a power consumption model.

In some embodiments, the apparatus 400 includes a deep neural network 404 and the model builder module 402 uses the deep neural network 404 to engage in machine learning to derive power consumption models for the various remote hardware resources 126. For a particular remote hardware resource 126, the deep neural network 404 uses execution data, workload type, characteristics of the remote hardware resource 126, and other data as input to the deep neural network 404. As various workloads are executed, the deep neural network 404 improves the power consumption model for the remote hardware resource 126. In other embodiments, the model builder module 402 uses machine learning techniques other than a deep neural network 404 to derive the power consumption models for the various remote hardware resources 126.

In some embodiments, the apparatus 400 includes a model library 406 for power consumption models derived by the model builder module 402. The model library 406 may be implemented with a database, a table, or other suitable data structure. The model builder module 402 and the consumption module 304 have access to the model library 406.

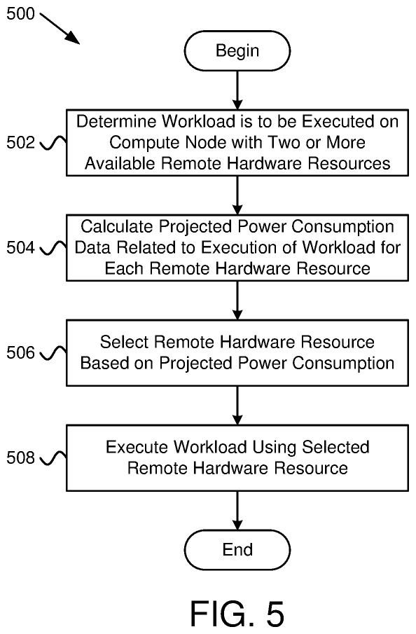

FIG. 5 is a schematic flow chart diagram illustrating one embodiment of a method 500 for a composed compute system with energy aware orchestration. The method 500 begins and determines 502 that a compute node 108 is scheduled to execute a workload. The compute node 108 includes a remote resource 116 available for use in execution of the workload. The remote resource 116 functions as being installed on the compute node 108 and is remote to the compute node 108. Two or more remote hardware resources 126 are available for selection as the remote resource 116.

The method 500 calculates 504, for each of the two or more remote hardware resources 126, projected power consumption data related to execution of the workload. In one example, the method 500 selects power consumption models from the model library 406 for calculating 504 the projected power consumption data. The power consumption data for the two or more remote hardware resources 126 includes power consumption data based on an environment where each of the two or more the remote hardware resources 126 is located.

The method 500 selects 506 a remote hardware resource 124 of the two or more remote hardware resources 126 for use during execution of the workload based on the projected power consumption data of the two or more remote hardware resources 126 and submits 508 the workload to the compute node 108 for execution while using the selected remote hardware resource 124, and the method 500 ends. In various embodiments, the method 500 is implemented using the workload schedule module 302, the consumption module 304, the resource selection module 306 and/or the submission module 308 and may interact with the workload orchestrator 104 and/or the POD manager 106.

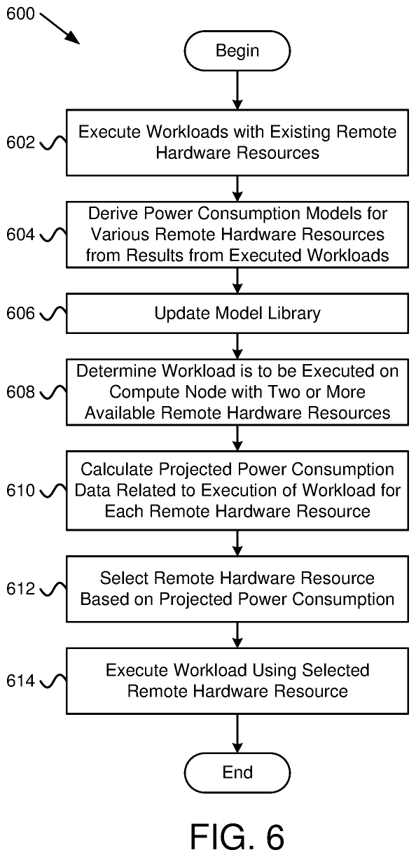

FIG. 6 is a schematic flow chart diagram illustrating another embodiment of a method 600 for a composed compute system with energy aware orchestration. The method 600 begins and executes 602 workloads on existing remote hardware resources 126 and derives 604 power consumption models for various remote hardware resources 126 of a composed system (e.g. 100, 200) based on results from execution of workloads on the existing remote hardware resources 126. The method 600 updates 606 the model library 406 with the derived power consumption models. The method 600, in some embodiments, uses machine learning in deriving 604 the power consumption models.

The method 600 determines 608 that a compute node 108 is scheduled to execute a workload. The compute node 108 includes a remote resource 116 available for use in execution of the workload. The remote resource 116 functions as being installed on the compute node 108 and is remote to the compute node 108. Two or more remote hardware resources 126 are available for selection as the remote resource 116.

The method 600 calculates 610, for each of the two or more remote hardware resources 126, projected power consumption data related to execution of the workload for each available remote hardware resource 126. The method 600, in some embodiments, uses power consumption models from the model library 406 to calculate 610 the projected power consumption data. The power consumption data for the two or more remote hardware resources 126 includes power consumption data based on an environment where each of the two or more the remote hardware resources 126 is located.

The method 600 selects 612 a remote hardware resource 124 of the two or more remote hardware resources 126 for use during execution of the workload based on the projected power consumption data of the two or more remote hardware resources 126 and submits 614 the workload to the compute node 108 for execution while using the selected remote hardware resource 124, and the method 600 ends. In various embodiments, the method 600 is implemented using the workload schedule module 302, the consumption module 304, the resource selection module 306, the submission module 308, the model builder module 402 and/or the deep neural network 404 and may interact with the model library 406, the workload orchestrator 104 and/or the POD manager 106.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining that a compute node is scheduled to execute a workload, the compute node comprising a remote resource available for use in execution of the workload, wherein the remote resource functions as being installed on the compute node and is remote to the compute node and wherein two or more remote hardware resources are available for selection as the remote resource;
calculating, for each of the two or more remote hardware resources, projected power consumption data related to execution of the workload, wherein the projected power consumption data for the two or more remote hardware resources comprises power consumption data based on an environment where each of the two or more the remote hardware resources is located;
selecting a remote hardware resource of the two or more remote hardware resources for use during execution of the workload based on the projected power consumption data of the two or more remote hardware resources; and
submitting the workload to the compute node for execution while using the selected remote hardware resource.

2. The method of claim 1, wherein calculating, for each of the two or more remote hardware resources, the projected power consumption data related to execution of the workload further comprises calculating, for a remote hardware resource of the two or more remote hardware resources, the projected power consumption data using a power consumption model applicable to the remote hardware resource.

3. The method of claim 2, further comprising deriving the power consumption model for the remote hardware resource using power consumption data of one or more remote hardware resources related to execution of one or more previously executed workloads.

4. The method of claim 3, wherein the one or more previously executed workloads are the same or similar to the workload scheduled for execution and the one or more remote hardware resources related to execution of the one or more previously executed workloads are similar to a remote hardware resource for which the power consumption model is being derived.

5. The method of claim 3, wherein deriving the power consumption model further comprises using, for each remote hardware resource of the two or more remote hardware resources, a baseline power consumption while not executing a workload, measurement of power consumption of the remote hardware resource during execution of a workload, a workload type, a device type of the remote hardware resource, a model number of the remote hardware resource, a temperature of the remote hardware resource, a temperature of a computing device where the remote hardware resource resides, configuration information for the remote hardware resource and/or an ambient temperature of a space where the remote hardware resource is located.

6. The method of claim 3, wherein deriving the power consumption model further comprises using machine learning to derive the power consumption model.

7. The method of claim 1, wherein each of the two or more remote hardware resources comprise a central processing units (“CPU”), a graphics processing unit (“GPU”), a field-programmable gate array (“FPGA”), an accelerator, or a non-volatile data storage device.

8. The method of claim 1, wherein selecting a remote hardware resource of the two or more remote hardware resources comprises selecting a remote hardware resource of the two or more remote hardware resources based at least a part on management of heat within a space and/or one or more computing devices comprising the two or more remote hardware resources.

9. The method of claim 8, wherein selecting a remote hardware resource of the two or more remote hardware resources comprises selecting a remote hardware resource of the two or more remote hardware resources based on management of heat and one or more other workload execution performance factors for execution of the workload.

10. An apparatus comprising:
a processor; and
a memory that stores program code executable by the processor to:
determine that a compute node is scheduled to execute a workload, the compute node comprising a remote resource available for use in execution of the workload, wherein the remote resource functions as being installed on the compute node and is remote to the compute node and wherein two or more remote hardware resources are available for selection as the remote resource;
calculate, for each of the two or more remote hardware resources, projected power consumption data related to execution of the workload, wherein the projected power consumption data for the two or more remote hardware resources comprises power consumption data based on an environment where each of the two or more the remote hardware resources is located;
select a remote hardware resource of the two or more remote hardware resources for use during execution of the workload based on the projected power consumption data of the two or more remote hardware resources; and
submit the workload to the compute node for execution while using the selected remote hardware resource.

11. The apparatus of claim 10, wherein calculating, for each of the two or more remote hardware resources, the projected power consumption data related to execution of the workload further comprises program code executable by the processor to calculate, for a remote hardware resource of the two or more remote hardware resources, the projected power consumption data using a power consumption model applicable to the remote hardware resource.

12. The apparatus of claim 11, wherein the program code executable by the processor further comprises program code to derive the power consumption model for the remote hardware resource using power consumption data of one or more remote hardware resources related to execution of one or more previously executed workloads.

13. The apparatus of claim 12, wherein the one or more previously executed workloads are the same or similar to the workload scheduled for execution and the one or more remote hardware resources related to execution of the one or more previously executed workloads are similar to the remote hardware resource for which the power consumption model is being derived.

14. The apparatus of claim 12, wherein the program code executable to derive the power consumption model further comprises program code executable to use machine learning to derive the power consumption model.

15. The apparatus of claim 10, wherein selecting a remote hardware resource of the two or more remote hardware resources comprises selecting a remote hardware resource of the two or more remote hardware resources based at least a part on management of heat within a space and/or one or more computing devices comprising the two or more remote hardware resources.

16. The apparatus of claim 15, wherein selecting a remote hardware resource of the two or more remote hardware resources comprises selecting a remote hardware resource of the two or more remote hardware resources based on management of heat and one or more other workload execution performance factors for execution of the workload.

17. A program product comprising a computer readable storage medium comprising program code, the program code being configured to be executable by a processor to perform operations comprising:
determining that a compute node is scheduled to execute a workload, the compute node comprising a remote resource available for use in execution of the workload, wherein the remote resource functions as being installed on the compute node and is remote to the compute node and wherein two or more remote hardware resources are available for selection as the remote resource;
calculating, for each of the two or more remote hardware resources, projected power consumption data related to execution of the workload, wherein the projected power consumption data for the two or more remote hardware resources comprises power consumption data based on an environment where each of the two or more the remote hardware resources is located;
selecting a remote hardware resource of the two or more remote hardware resources for use during execution of the workload based on the projected power consumption data of the two or more remote hardware resources; and
submitting the workload to the compute node for execution while using the selected remote hardware resource.

18. The program product of claim 17, wherein calculating, for each of the two or more remote hardware resources, the projected power consumption data related to execution of the workload further comprises calculating, for a remote hardware resource of the two or more remote hardware resources, the projected power consumption data using a power consumption model applicable to the remote hardware resource.

19. The program product of claim 18, further comprising deriving the power consumption model for the remote hardware resource using power consumption data of one or more remote hardware resources related to execution of one or more previously executed workloads.

20. The program product of claim 19, wherein the one or more previously executed workloads are the same or similar to the workload scheduled for execution and the one or more remote hardware resources related to execution of the one or more previously executed workloads are similar to the remote hardware resource for which the power consumption model is being derived.
